(19) United States
(12) Patent Application Publication
(10) Pub. No.: US 2012/0234084 A1
(43) Pub. Date: Sep. 20, 2012

(54) Device for detecting a combustion chamber pressure of an internal combustion engine

(76) Inventors: Markus Ledermann, Salach (DE); Petra Siegenthaler, Wutha-Farnroda (DE); Holger Scholzen, Stuttgart (DE); Christian Doering, Stuttgart (DE); Sven Zinober, Friolzheim (DE)

(21) Appl. No.: 13/320,835

(22) PCT Filed: Mar. 22, 2010
(86) PCT No.: PCT/EP2010/053672

§ 371 Date: Mar. 19, 2012

(30) Foreign Application Priority Data
May 25, 2009 (DE) 102009026436.1

(51) Int. Cl. G01M 15/08

(52) U.S. Cl. 73/114.18

(57) ABSTRACT

A device for detecting a combustion chamber pressure of an internal combustion engine includes a sensor housing which is designed to be at least partially introduced into a combustion chamber of the internal combustion engine. On the combustion chamber side, the sensor housing has an opening which is closed by at least one diaphragm. At least one mechanical-electrical transducer element is accommodated inside the sensor housing. Furthermore, at least one transmission element is provided, which is implemented separately from the sensor housing, for transmitting a deformation of the diaphragm to the mechanical-electrical transducer element.

### BACKGROUND OF THE INVENTION

1. Field of the Invention

The present invention relates to a device for detecting a combustion chamber pressure of an internal combustion engine, which is usable in particular in gasoline engines.

2. Description of Related Art

Devices of this type form an essential component of modern engine controllers, because the combustion chamber pressure must be detected very precisely, in particular for the purpose of reducing consumption and emissions.

Therefore, devices for detecting a combustion chamber pressure, which, however were predominantly developed for diesel engines, are known from the related art. Published German patent application document DE 10 2005 035 062 A1, for example, describes a device for detecting a combustion chamber pressure of an internal combustion engine which has a sheathed element glow plug having a housing cover that extends in a direction of installation of the sheathed element glow plug and a pressure detecting element located in the sheathed element glow plug. The housing cover of the sheathed element glow plug is used for transmitting the combustion chamber pressure to the pressure detecting element. Published international patent application document WO 2006/089446 A1 describes a component for installation in power or pressure sensors in a glow plug, in particular. The component includes a measuring element in the form of a disc or perforated disc made of piezoelectric material as well as electrodes in the form of perforated discs or discs, which press against the measuring element on both sides, having contact points for the contact to lines. Furthermore, one or more transmission bodies situated on both sides outside the electrodes are provided.

Combustion chamber pressure sensors, which are easy to mass manufacture and which can be used as stand-alone combustion chamber pressure sensors for gasoline engines, in particular, are, however, not known so far from the related art. However, the concepts developed for diesel engines cannot be easily transferred to gasoline engines. Numerous technical challenges generally occur in the construction of combustion chamber pressure sensors, in particular in the case of gasoline engines. Thus, due to the combustion in the combustion chamber of the internal combustion engine, high temperatures, which instantaneous measuring and analyzing principles generally cannot bear up against, occur. Moreover, the devices have to work error-free within a broad temperature range without allowing the thermal stresses to change the measuring signals. External mechanical influences such as screwing-in torques during the installation of the device in a combustion chamber wall, for example a cylinder head, may not have an effect on the signal quality or change the measuring signals of the devices.

### BRIEF SUMMARY OF THE INVENTION

Therefore, a device for detecting a combustion chamber pressure of an internal combustion engine is provided which meets these challenges. The device is usable in gasoline engines, in particular. The device includes at least one sensor housing, i.e., an element which entirely or partially encloses further components such as a sensor housing designed at least partially in the form of a hollow cylinder. The sensor housing may be made of a metallic material, for example, and is designed to be introduced at least partially into the combustion chamber of the internal combustion engine. For example, the sensor housing may be fastened directly or indirectly in a combustion chamber wall of the internal combustion engine, so that the sensor housing protrudes at least partially by its front end, for example, into the combustion chamber of the internal combustion engine.

On the combustion chamber side, the sensor housing has an opening that is closed by at least one diaphragm. This may be a circular or a polygonal opening, for example. A diaphragm may be understood, for example, as an element which is deformable or movable in at least one direction, which extends perpendicularly to an axis of the sensor housing, for example, whose lateral extension preferably exceeds its thickness by at least a factor of 10, in particular by at least a factor of 100. The diaphragm may by designed as a metal diaphragm, for example, such as a metal film, and may also be implemented in one piece with the sensor housing and/or may be joined non-positively and/or positively and/or integrally to the sensor housing in the area of the opening. It is particularly preferable if the sensor housing has a hollow-cylindrical design at least in the area of the opening, the diaphragm, for example, being welded as a metal diaphragm, for example, on the sensor housing, on the edge of the sensor housing around the opening. Another type of connection to the sensor housing is fundamentally possible, such as a non-positive connection by a cap nut, for example. The diaphragm preferably closes the opening completely pressure-tight, at least in the range of pressures typically occurring in combustion chambers.

Furthermore, the device includes at least one mechanical-electrical transducer element in the sensor housing. This is generally to be understood as an element which may convert mechanical actions, for example a force action and/or a pressure action and/or a length change in the transducer element, into electrical signals. Reference is essentially made hereafter to piezoelectric transducer elements. Alternatively or additionally, the mechanical-electrical transducer element may also, however, include other types of transducer elements which are designed to convert mechanical signals into electrical signals.

Furthermore, the device has at least one transmission element, which is implemented separately from the sensor housing, for transmitting a deformation of the diaphragm to the mechanical-electrical transducer element. In this way, for example, a deflection of the diaphragm due to the combustion chamber pressure may be transmitted via the transmission element to the mechanical-electrical transducer element, so that an electrical signal may be generated corresponding to the deflection of the diaphragm and thus corresponding to the combustion chamber pressure. A transmission element is to be understood fundamentally as an arbitrary element, using which movements and/or deformations of the diaphragm may also be axially transmitted, preferably essentially rigidly, to the mechanical-electrical transducer element. For example, the transmission element may have an essentially rod-shaped design and may preferably be installed on an axis of the device. The transmission element may also be designed in multiple parts.

As described above, the transmission element is implemented separately from the sensor housing. This means that the device has at least two transmission paths, via which forces and/or length changes in components of the device, which are exposed directly to the combustion chamber, for example the diaphragm and/or a front side of the sensor housing facing the combustion chamber, may be transmitted to the mechanical-electrical transducer element. Thus, for example, the sensor housing itself may be a part of a first transmission path, and the transmission element may be part of a second transmission path, which is essentially not coupled to the first transmission path. For example, thermally induced expansions of the device may be transmitted via the first transmission path and the second transmission path to the mechanical-electrical transducer element, preferably essentially without coupling of the two paths. This process is explained below in greater detail. The first transmission path may concentrically enclose the second transmission path.

Because thermally induced expansions of the device are transmittable via both transmission paths to the mechanical-electrical transducer element, it is particularly preferable if the device has at least one compensation body for compensating for different thermal expansions in the two transmission paths. It is particularly preferable if the transmission element itself includes at least one compensation body, which is designed to compensate for differing thermal expansions between the first transmission path and the second transmission path. Thus, for example, the compensation body may be designed with respect to its length and its thermal expansion coefficient in such a way that it ensures, at least within typical temperature ranges to which the device may be exposed, that the thermal expansions of the first and the second transmission paths are at least largely identical, for example within a tolerable deviation of not greater than 20%, in particular not greater than 10%, and preferably not greater than 5%.

For example, in the event of a cold start, temperatures of −40° C. may briefly prevail. During operation, the described transmission path typically does not heat through homogeneously, but rather a temperature gradient will normally be established from the combustion chamber, for example at a diaphragm temperature of up to approximately 550° C., up to the mechanical-electrical transducer element, for example at a temperature of the piezoelectric quartz of up to approximately 200° C. The temperature compensation may then be performed, for example, on the basis of empirically ascertained temperature gradients ascertained from engine measurements, for example. A temperature compensation may typically only be implemented either for homogeneous temperatures or for temperature gradients, in particular homogeneous temperature gradients. The temperature compensation is preferably implemented in such a way that a pretensioning force, a pretensioning force of the mechanical-electrical transducer element, for example, does not change or only changes insignificantly upon the transition from an idling temperature gradient to a full load temperature gradient or vice versa. A change in the pretensioning force resulting from the change in the ambient temperature may normally be tolerated in this case, because typically a high time constant prevails and most of the time the influence of the measuring signal is negligible, in particular in connection with a reset of a measuring signal after each cycle, for example. It may thus be ensured, for example, that over the typically occurring temperature range in which the device is used, if possible, no solely thermally induced transducer signal or change in the transducer signal of the mechanical-electrical transducer occurs due to differing expansions in the first transmission path and in the second transmission path. As described above, however, this may also be alternatively or additionally achieved by situating the at least one compensation body at another location in one of the two transmission paths and/or by suitable material selection of the elements involved in the transmission paths.

Alternatively or additionally to the at least one compensation body, the transmission element, which may be constructed in multiple parts, may also have at least one heat protection insulating body having thermally insulating properties. In this way, it may be ensured that high temperatures and/or large quantities of heat may not be transmitted via the transmission element from the combustion chamber to the mechanical-electrical transducer element, which could be damaged by them. For example, the heat protection insulating body may include at least one ceramic material, which may have high thermally insulating properties. Other types of materials are also possible. The heat protection insulating body may also be constructed in multiple parts, for example. Alternatively or additionally to thermal insulation, the heat protection insulating body may also have electrically insulating properties. This may be ensured in that the heat protection insulating body having the thermally insulating properties also has electrically insulating properties itself. Alternatively, however, a multipart construction may also be provided, in which the heat protection insulating body has at least one electrically insulating component in addition to at least one thermally insulating component.

Furthermore, the device may include at least one contact element for electrical contacting of the mechanical-electrical transducer element. In particular, this may be a rigid contact element, i.e., a contact element which only changes its shape insignificantly or not at all under the effect of its intrinsic weight force. In particular, the contact element may include at least one busbar, i.e., a rigid element which has current-conducting properties, a metallic element, for example. The contact element is preferably to be designed in such a way that it has at least partial axial flexibility, for example sectionally, i.e., a flexibility in its longitudinal extension direction, parallel to the axis of the device, for example. This may be achieved, for example, in that the contact element is at least partially designed to have elastic properties. Alternatively or additionally, the contact element, for example the at least one busbar, may for example at least sectionally allow flexibility in the sensor longitudinal direction in that a double lay is provided. This may be performed similarly to corrugated cardboard, for example, in that a busbar is equipped with two external tracks, for example, between which at least one elastic element is provided, for example a folded metal track. In this way, in particular in the area of a contact of the mechanical-electrical transducer element, axial flexibility of the contact element may be provided, for example, in that the contact element is designed in such a way, for example bent, that it has one or more sections having an extension perpendicular to the axis. In this way or in another way, the one or more contact element(s) may contribute to a strain relief of the mechanical-electrical transducer element, so that, for example, a force action may act on the mechanical-electrical transducer element, but a travel which is, for example, impressed on the mechanical-electrical transducer element by bracings is reduced. However, this travel is significant for an error signal generated in the mechanical-electrical transducer element, for example a piezoelectric quartz, by the bracings.

The mechanical-electrical transducer element may be directly or indirectly supported against an insulating body on its side facing away from the combustion chamber. This insulating body may have electrically insulating properties, for example. Furthermore, the mechanical-electrical transducer element may alternatively or additionally be supported directly or indirectly against the sensor housing via at least one fastening unit on its side facing away from the combustion chamber. The fastening unit may be a metal fastening unit, for example, such as a metal ring, which may be integrally and/or positively and/or non-positively joined to the sensor housing, for example. Welding of the fastening unit to the sensor housing is particularly preferred. Other fastening units are also fundamentally possible, however.

Furthermore, the mechanical-electrical transducer element may be separated from the sensor housing by at least one sensor holder. In particular, this sensor holder may include a sensor holder which at least partially encompasses, in particular encloses, the mechanical-electrical transducer element, for example, a sensor holder which concentrically encloses this transducer element. This sensor holder may be, for example, at least partially designed as a sleeve. The sensor holder may, for example, have thermally and/or electrically insulating properties and/or vibration-damping properties. The sensor holder may be entirely or partially made of plastic, ceramic, polyceramic, or combinations of the named and/or other materials. The sensor holder may also at least partially enclose at least one part of the transmission element, for example the heat protection insulating body and/or the compensation body. In this way, the two above-described transmission paths may be additionally separated from one another. The sensor holder itself should not have any direct contact with the diaphragm, so that the sensor holder itself preferably does not form a component of the above-mentioned transmission paths. Alternatively or additionally, the sensor holder may include and/or enclose further elements of the device, in particular further elements which form part of the second transmission path. The sensor holder may thus at least partially enclose elements, for example the insulating body, on the side of the mechanical-electrical transducer element facing away from the combustion chamber, for example.

The device may further include at least one sealing housing which at least partially encloses the sensor housing, for example a sealing cone housing. This sealing housing may be designed to allow a fastening unit to fasten the device in a combustion chamber wall, so that at least a pressure on the combustion chamber side may be applied to the diaphragm. This fastening unit may include a non-positive and/or positive fastening unit, for example, a screwing into a combustion chamber wall, for example. A sealing cone on the sealing housing may, for example, increase the sealing effect to not induce leaks in a cylinder head, for example. For this purpose, the sealing housing is to be designed in such a way, join the sensor housing in such a way, for example, that the mechanical-electrical transducer element is supported from the outside of the combustion chamber. As described above, this may be accomplished, for example, in that only one part of the device protrudes into the combustion chamber, in particular a part of the device which includes the diaphragm, while the at least one mechanical-electrical transducer element is supported from the outside of the combustion chamber, preferably in an area in which only moderate temperatures prevail during the operation of the internal combustion engine. For example, the mechanical-electrical transducer element may be situated in an area in which temperatures do not exceed 200° C.

The sealing housing may, for example, be joined to the sensor housing in such a way that the sensor housing essentially remains free of axial stresses and/or torsional stresses when the sealing housing is fastened in the combustion chamber wall, when screwing it into a cylinder head, for example, so that no axial stresses and/or torsional stresses are transmitted to the mechanical-electrical transducer element. This result may, for example, be ensured in that the sealing housing encloses the sensor housing at least partially, but is joined to it only in one area or in multiple uncritical areas, for example, using an integral and/or positive connection, for example, in the form of a weld, for example, preferably in the form of a single weld, in the form of a single peripheral weld, for example. In this case, axial and/or torsional stresses in the sealing housing which may occur in the combustion chamber wall when fastening are not transmitted to the inside of the sensor housing and are thus not transmitted to the mechanical-electrical transducer element. A transmission of radial stresses may, however, be tolerated to a certain extent. The sensor housing and the first and/or second transmission path may thus be designed to not be coupled mechanically to the sealing housing the one weld, for example. As a result, an axial compressive stress and/or a torsional stress, which may in particular be generated by a screwing-in torque within the sealing housing, do not act on the first and/or second transmission path, so that these stresses may influence the pressure measurement or the force measurement only insignificantly or not at all.

The provided device has numerous advantages with respect to known devices in one or multiple of the above-described specific embodiments, which are positively noticeable in particular when used in gasoline engines. The device is thus designed in such a way that the high temperatures occurring during combustion in the combustion chamber may influence the signals only insignificantly or not at all. The pressure signal from the combustion chamber may be relayed within the device into an area in which temperatures compatible with the mechanical-electrical transducer element prevail. The provided construction additionally allows a measuring signal transmission with minimal signal reduction and/or signal change. Furthermore, external mechanical influences, for example the screwing-in torque, are kept away from the second transmission path, i.e., from the transmission path of the pressure, the force, and the electrical signal. Through the proposed second transmission path, which may be used as a relevant force path and whose transmission is received by the mechanical-electrical transducer element, the pressure signal may be converted with reduced losses into a force, relayed to the measuring element, and converted into an electrical signal therein, which is in turn conducted to an analysis circuit, integrated in the device itself and/or situated entirely or partially outside the device. The mechanical-electrical transducer element and/or the analysis circuit may be situated in areas having compatible temperatures. Furthermore, the above-described components of the device may be optimized in such a way that the measuring signal is not impaired by mechanical and/or thermal influences. Thus, in particular temperature influences and/or mechanical influences which may occur due to the busbars, for example, may be minimized by the above-described embodiment according to the present invention.

### BRIEF DESCRIPTION OF THE DRAWINGS

FIG. 1 shows an exemplary embodiment of a device according to the present invention for detecting a combustion chamber pressure of an internal combustion engine.

### DETAILED DESCRIPTION OF THE INVENTION

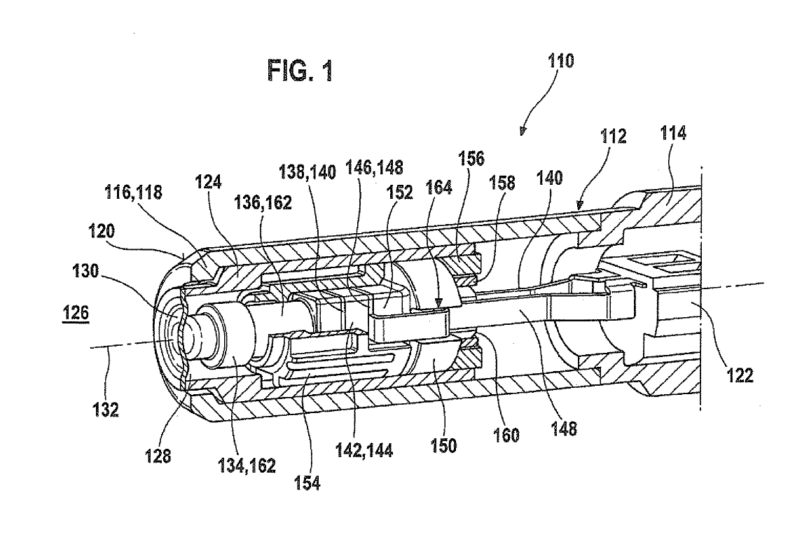

FIG. 1 shows an exemplary embodiment of a device 110 according to the present invention for detecting a combustion chamber pressure of an internal combustion engine, which may be used in particular in a gasoline engine. Device 110 includes a housing 112 constructed in multiple parts, having a main body 114 and a sealing housing 118, designed as a sealing cone housing 116, having a sealing cone 120 on the combustion chamber side. Main body 114, which may be made of a plastic material and/or a ceramic material, for example, accommodates a contact module 122. Signals of device 110 may already be entirely or partially processed in this contact module 122 and/or relayed outward via one or more interfaces (not shown in FIG. 1). Sealing housing 118, which has an essentially cylindrical design, and which in turn concentrically encloses a sensor housing 124, is placed on the main body. This sensor housing 124 has an opening 128 on its side facing a combustion chamber 126, which opening is closed by a diaphragm 130. This diaphragm 130 is designed to deform or deflect into a direction of an axis 132 of device 110 when acted on by the pressure from combustion chamber 126.

Inside sensor housing 124, a compensation body 134 is connected to diaphragm 130 along axis 132. The compensation body 134 in turn joins a heat protection insulating body 136 in the axial direction, which ends in a first contact area extending perpendicularly to axis 132 of a first busbar 140, which otherwise extends essentially parallel to axis 132. A mechanical-electrical transducer element 142 joins the heat protection insulating body 136 in the form of a piezoelectric quartz 144. A piezoelectric quartz 144 may be understood fundamentally, alternatively or additionally to a quartz having piezoelectric properties, to be any piezoelectric material. The side of piezoelectric quartz 144 facing away from combustion chamber 126 joins a second contact area 146 in the axial direction, which is implemented as a section extending essentially perpendicularly to axis 132 of a second busbar 148, which otherwise preferably extends essentially parallel to axis 132. Both contact areas 138 and 146 form contacts and/or electrodes of piezoelectric quartz 144. Alternatively, electrodes of piezoelectric quartz 144 may also be designed in another way and/or as components separate from busbars 140, 148.

An insulating body 150 joins a second contact area 146 in the axial direction on the side of piezoelectric quartz 144 facing away from combustion chamber 126. Insulating body 150 has a section 152 on the combustion chamber side having a reduced diameter, which is enclosed, together with piezoelectric quartz 144 and heat protection insulating body 136, by a sensor holder 154. A fastening unit 156 in the form of a metal ring joins the insulating body in the axial direction on the side facing away from combustion chamber 126. This metal ring may be welded to sensor housing 124, for example, as described below in greater detail. The metal ring of fastening unit 156 in turn encloses an insulating sleeve 158 in the exemplary embodiment shown, via which fastening unit 156 is separated from an extension 160 of insulating body 150.

Device 110, which is designed as a combustion chamber pressure sensor, protrudes on the diaphragm side into combustion chamber 126 of the internal combustion engine. The pressure applied in the combustion chamber is converted into a force inside diaphragm 130, which acts on compensation body 134. Compensation body 134 has the function, on the one hand, of relaying the force to heat protection insulating body 136, which forms a transmission element 162 together with compensation body 134. On the other hand, compensation body 134 has the function of compensating for differing thermal expansions of adjacent components.

Piezoelectric quartz 144 is thus part of a structure which has two parallel transmission paths. A first transmission path may include diaphragm 130, sensor housing 124 and fastening unit 156. A second transmission path may include diaphragm 130, compensation body 134, heat protection insulating body 136, first busbar 140 or its first contact area 136, piezoelectric quartz 144, second busbar 148 or its second contact area 146, insulating body 150, and fastening unit 156. The inner, second transmission path expands differently than the outer, second transmission path enclosing it because of differing thermal expansion coefficients of these components. These differing expansions finally result in additional loading or relief of piezoelectric quartz 144, which may be superimposed with the force action resulting from the combustion chamber pressure and typically cannot be differentiated therefrom. This superposition thus typically results in a measuring error. The present invention therefore provides that the differing expansions be suppressed in that compensation body 134 is preferably implemented with respect to its length and/or its thermal expansion coefficient in such a way that it ensures that the thermal expansions of the inner and outer transmission paths are identical. In many cases, however, this expansion is only possible for a specific temperature or a specific temperature gradient. Nonetheless, by choosing a suitable material for compensation body 134, at least a minimization of expansion errors as a result of differing thermal expansions in the two transmission paths may be achieved at least in the relevant temperature range of device 110.

Heat protection insulating body 136 has the function, on the one hand, of interrupting the thermal path from combustion chamber 126 to piezoelectric quartz 144, i.e., protecting piezoelectric quartz 144 from overheating. On the other hand, it is preferably also used as an electrical insulator, which ensures that the electrical charges transmitted from piezoelectric quartz 144 to busbars 140, 148 are relayed only on the route provided for them via busbars 140, 148 themselves. Depending on the specific requirements for the electrical insulation and/or the thermal insulation, it may be advisable or necessary to design heat protection insulating body 136 in multiple parts, and to divide it into a thermally insulating component and an electrically insulating component, for example, whose materials may then be optimized for the corresponding requirements.

Piezoelectric quartz 144 is made of piezoelectric material and converts a force, in this case the force resulting from the combustion chamber pressure signal, into an electrical charge, which is proportional to the applied force, i.e., in this case to the applied pressure. Piezoelectric quartz 144 converts the force into an electrical charge via the detour of a length change. The electrical charge is converted into a voltage proportional to the charge and/or the force and/or the pressure, which may then be relayed to an engine control unit, in an analysis circuit (not shown in FIG. 1), for example, which may be entirely or partially accommodated in contact module 122, but which may alternatively or additionally also be entirely or partially accommodated outside device 110.

Busbars 140, 148 each have essentially the same functions. On the one hand, they transmit the charges which are generated in piezoelectric quartz 144 to the analysis circuit. Because a force action, which may in turn generate an error-relevant measuring signal, may also arise on piezoelectric quartz 144 due to bracings in busbars 140, 148 themselves, which may arise through thermal expansions or through internal mechanical stresses after the welding of the busbars to the other components in the rear part of device 110 facing away from combustion chamber 126, for example, the busbars preferably have a strain relief function. The busbars may accordingly have a double lay, in particular in the area between insulating body 150 and fastening unit 156, which allows a certain flexibility in the sensor longitudinal direction, i.e., along axis 132. For this purpose, busbars 140, 148 may be designed like corrugated cardboard, as described above. Alternatively or additionally, as indicated in FIG. 1, busbars 140, 148 may also have one or multiple kinks and/or bends, which are used as spring elements and may ensure the described strain relief. Busbars 140, 148 may also be designed differently for elasticity, i.e., act elastically in the direction of axis 132. The force action of bracings on piezoelectric quartz 144 is not reduced by the described flexibility, but the impressed travel is reduced. The impressed travel, i.e., the change in piezoelectric quartz 144, is decisive for the error signal generated in piezoelectric quartz 144.

Insulating body 150, which may be made of a ceramic material and/or a plastic material, for example, has the main function of electrically insulating piezoelectric quartz 144 and one or both of busbars 140, 148, for example second busbar 148, from adjacent components. Furthermore, insulating body 150 offers space for busbars 140, 148, so that they may be guided to the analysis circuit. In particular, insulating body 150 preferably also offers space for strain relief strands 164 and/or other types of spring elements of busbars 140, 148, in order to achieve the strain relief action described above.

Fastening unit 156, which is designed as a metal fastening unit, for example, is used as a buttress for the previously described second transmission path, i.e., the inner force path. It is preferably welded to sensor housing 124 in the first transmission path, i.e., the outer force path. The welding may be performed by applying a pre-stress, for example, which may be necessary so that all components rest securely and solidly on one another in every operating state. In addition, a pre-stress of this type may be necessary for the mode of operation of piezoelectric quartz 144.

Insulating sleeve 158 is used for the purpose of avoiding an electrical short-circuit between busbars 140, 148 and fastening unit 156, even under high mechanical loads during the use of device 110, e.g., mechanical shocks.

The first transmission path, i.e., the outer force path, also begins with above-described diaphragm 130, which may be welded onto sensor housing 124 in the area of opening 128, for example. Sensor housing 124 is used as a carrier of the components of the second transmission path, i.e., the inner force path, and for the purpose of protecting it from external mechanical influences. The rear end of sensor housing 124 is preferably welded to fastening unit 156, as described above. Sensor holder 154 is situated between sensor housing 124 and the inner force path. This sensor holder may be entirely or partially made of plastic, ceramic, polyceramic, or similar material, for example, as a one-piece, sleeve-shaped part, for example. Furthermore, it may be designed for the purpose of aligning and accommodating piezoelectric quartz 144, busbars 140, 148, heat protection insulating body 136 and isolating body 150 and electrically insulating them from sensor housing 124.

Sensor housing 124 encloses the inner force path and forms, in cooperation with the inner and the outer force paths, an independent assembly which contains the entire sensor function and may theoretically function as a separate sensor, because diaphragm 130 and fastening unit 156 are welded to sensor housing 124. This sensor functional assembly is also accommodated in sealing housing 118 in this exemplary embodiment, welded into sealing cone housing 116, for example. A structure may thus be achieved which may be screwed in by a user into a cylinder head. High torques (screwing torques) and high axial pre-stresses arise as this structure is screwed in. These axial pre-stresses could induce measuring errors if they acted on the sensor functional assembly. The sensor functional assembly is therefore peripherally welded into sealing cone housing 116, preferably only at one point. A transmission of axial pre-stress forces or torques to the sensor functional assembly is therefore preferably largely prevented. The hermeticity of the sensor inner chamber is simultaneously also implemented by the welding of the sensor functional assembly to sealing cone housing 116.

1-10. (canceled)

11. A device for detecting a combustion chamber pressure of an internal combustion engine, comprising:
a sensor housing configured to be positioned at least partially inside a combustion chamber of the internal combustion engine, wherein the sensor housing has an opening which is closed by at least one diaphragm on the combustion chamber side;
at least one mechanical-electrical transducer element accommodated inside the sensor housing; and
at least one transmission element which is implemented separately from the sensor housing, wherein the transmission element transmits a deformation of the diaphragm to the mechanical-electrical transducer element.

12. The device as recited in claim 11, wherein:
the sensor housing is part of a first transmission path;
the transmission element is part of a second transmission path;
thermally induced expansion of the device is transmitted to the mechanical-electrical transducer element via the first transmission path and the second transmission path; and
the transmission element includes at least one compensation body configured to compensate for differing thermal expansions between the first transmission path and the second transmission path.

13. The device as recited in claim 11, wherein the transmission element has at least one heat protection insulating body having thermally insulating properties.

14. The device as recited in claim 13, wherein the heat protection insulating body has electrically insulating properties.

15. The device as recited in claim 11, further comprising:
at least one contact element for electrically contacting the mechanical-electrical transducer element, wherein the contact element has axial flexibility.

16. The device as recited in claim 11, wherein a side of the mechanical-electrical transducer element facing away from the combustion chamber is supported against an insulating body having at least electrically insulating properties.

17. The device as recited in claim 11, wherein a side of the mechanical-electrical transducer element facing away from the combustion chamber is supported against the sensor housing via at least one fastening unit which is integrally joined to the sensor housing.

18. The device as recited in claim 11, wherein the mechanical-electrical transducer element is separated from the sensor housing by at least one sensor holder which at least partially surrounds the mechanical-electrical transducer element.

19. The device as recited in claim 11, further comprising:
at least one sealing housing which at least partially encloses the sensor housing, wherein the sealing housing is configured to enable the device to be fastened to a combustion chamber wall, and wherein the sealing housing is configured in such a way that the mechanical-electrical transducer element is supported from the outside of the combustion chamber.

20. The device as recited in claim 19, wherein the sealing housing is joined to the sensor housing in such a way that the sensor housing essentially remains free of axial and torsional stresses when the sealing housing is fastened to the combustion chamber wall.
